(19) United States
(12) Patent Application Publication
(10) Pub. No.: US 2009/0089432 A1
(43) Pub. Date: Apr. 2, 2009

(54) INFORMATION PROCESSING SYSTEM AND CONTROL METHOD THEREOF

(75) Inventor: Tatsuya Kurozumi, Hachioji-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/205,672

(22) Filed: Sep. 5, 2008

(30) Foreign Application Priority Data
Sep. 28, 2007 (JP) 2007-255740

(51) Int. Cl. G06F 15/173

(52) U.S. Cl. 709/226

(57) ABSTRACT

According to one embodiment, a control method of an information processing system including a service receiving apparatus connected to a network and a plurality of service providing apparatuses which provide services to the service receiving apparatus via the network, includes causing each of the plurality of service providing apparatuses to transmit service information stored in a nonvolatile memory disposed at each service providing apparatus to the service receiving apparatus, causing the service receiving apparatus to detect service providing apparatuses which can provide predetermined services on the basis of the service information transmitted from the service providing apparatus, transmitting the start commands for starting the service providing apparatuses to the detected service providing apparatuses, and causing the service providing apparatuses having received the start commands to start.

### CROSS-REFERENCE TO RELATED APPLICATIONS

This application is based upon and claims the benefit of priority from Japanese Patent Application No. 2007-255740, filed Sep. 28, 2007, the entire contents of which are incorporated herein by reference.

### BACKGROUND

1. Field

One embodiment of the invention relates to an information processing system and a control method thereof which receives a service capable of being provided from a plurality of service providing apparatuses in which an operating system (OS) has not started yet and starts any service providing apparatus for providing a predetermined service

2. Description of the Related Art

In a redundancy technique for a cluster server and a transfer technique of a virtual machine using a virtual technique, a prior art which takes over a service to another server exists. However, there is a problem that it becomes unclear for the client that which server (physical machine) can provide a target service when the service has been taken over, and if an address of a server providing the service is changed, in a case in which a client is not active, or the client is connected via a network.

In a mount system of network property, a technique by which a plurality of servers and clients are connected with one another via a network, and when clients output remote mount requests to servers, the corresponding-servers receive the requests to power on themselves and start operation systems (OSs), is disclosed in Jpn. Pat. Appln. KOKAI Publication No. 2000-305664.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram depicting a configuration of an information processing system of an embodiment regarding the invention;

FIG. 2 is an exemplary block diagram depicting a system configuration of each server depicted in FIG. 1;

FIG. 3 is an exemplary block diagram depicting a configuration for starting only servers capable of providing predetermined services among service providing devices not have started yet;

FIG. 4 is an exemplary flowchart depicting a procedure of processing of a server and client computer of the one embodiment regarding the invention;

FIG. 5A and FIG. 5B are an exemplary block diagram depicting an example updating a record of service information in a case where relationships of a master and a slave of servers providing services;

FIG. 6A and FIG. 6B are an exemplary block diagram depicting an example for updating the record of the service information in a case where a virtual machine having an environment providing a service has transferred to another server;

FIG. 7 is an exemplary block diagram depicting an example in a case where servers and a client computer are located in different segments on a network;

FIG. 8 is an exemplary block diagram depicting a configuration for starting only servers capable of providing predetermined services among service providing apparatuses not have started yet; and

FIG. 9 is an exemplary flowchart depicting a procedure of processing of servers and a client computer of the one embodiment regarding the invention.

### DETAILED DESCRIPTION

Various embodiments according to the invention will be described hereinafter with reference to the accompanying drawings. In general, according to one embodiment of the invention, an information processing system including a service receiving apparatus connected to a network and a plurality of service providing apparatuses which provide services to the service receiving apparatus via the network, wherein each of the plurality of service providing apparatuses includes: a nonvolatile memory configure to store service information that is information of all services which can be provided to the service receiving apparatus, a service information transmission module configured to transmit information stored in the nonvolatile memory to the service receiving apparatus in response to a service information transmission request transmitted from the service receiving apparatus in a power ‘off’ state where a system does not operate, and a system start module configured to start the system in response to a start command transmitted from the service receiving apparatus in the power ‘off’ state, and the service receiving apparatus includes: a transmission request transmission module configured to transmit the service information transmission request to the service providing apparatuses in the power ‘off’ states, a selecting module configured to select service providing apparatuses which provide predetermined services from the plurality of service providing apparatuses in response to the service information transmitted from the service providing apparatuses in response to the service information transmission request, and a start command transmission module configured to transmit the start commands to the selected service providing apparatuses.

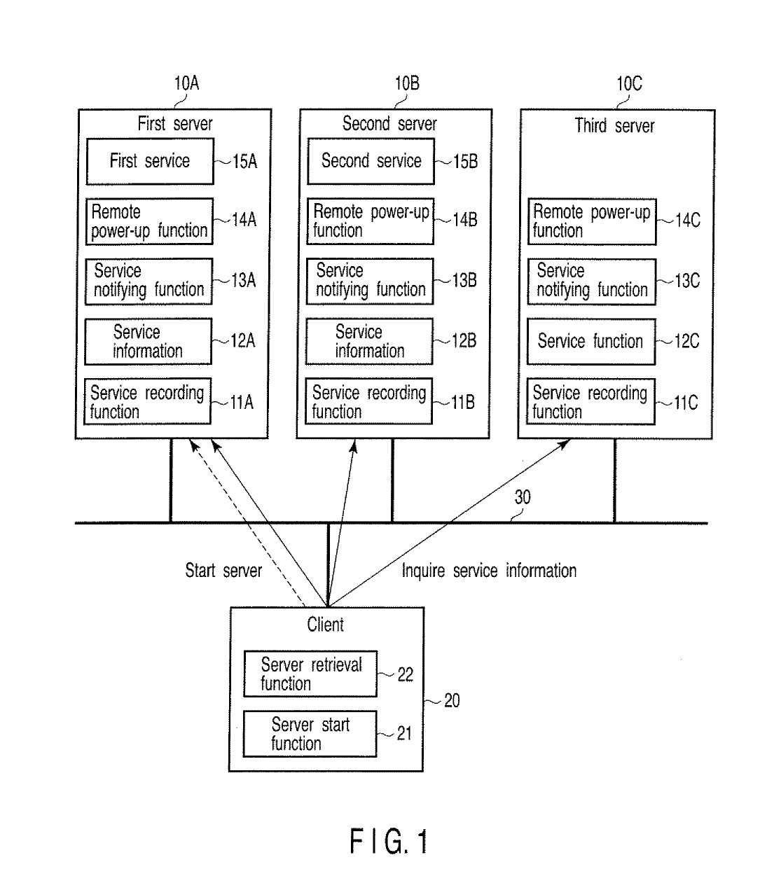

Referring now to FIG. 1, a configuration of an information processing system of one embodiment regarding the invention will be described. FIG. 1 shows a block diagram depicting an information processing system of the one embodiment of the invention.

The information processing system is composed of a first server (a service providing apparatus) 10A, a second server (a service providing apparatus) 10B, and a third server (a service providing apparatus) 10C, a client computer (a service receiving apparatus) 20, etc. The servers 10A-10C and the client computer 20 are connected to a network 30 in the same segment.

The first server 10A provides a first service 15A to the client computer 20. The second server 10B provides a second service 153 to the client computer 20. The third server 10C is equipment for substitution to be used when the first server 10A or the second server 10B has failed.

The first to third servers 10A-10C include service recording functions 11A-11C, service information 12A-12C, service notifying functions 13A-13C, and remote power-up functions 14A-14C, respectively.

The client computer 20 includes a server retrieval function 21 and a server start function 22.

The service recording functions 11A-11C to be provided by the first to third servers 10A-10C, respectively, collect information of service (hereinafter referred to as service information) which can be provided from the servers 10A-10C, respectively, and store the service information in nonvolatile memories as the service information 12A-12C, respectively. The service information 12A-12C includes information in relation to services, kinds of services, relationships between master servers and slave servers, etc., which can be provided from the servers 10A-10C, respectively. There is a possibility for the service information 12A-12C that the first to third servers 10A-10C cannot provide any service, and a possibility that the first to third servers 10A-10C can provide a plurality of kinds of services.

The service notifying functions 13A-13C operates by standby power supplies even if the first to third servers 10A-10C have not started yet, and operates even if the servers 10A-10C do not provide any service. The service notifying functions 13A-13C can reply the service information 12A-12C stored in the nonvolatile memories for the server retrieval function 21 of the client computer 20. Or the service notifying functions 13A-13C may voluntarily transmit service information to equipment connected to a network in the same segment by using a broadcast address (a multicasting address).

The remote power-up functions 14A-14C operates while the first to third servers 10A-10C operate by the standby power supply, and carry out to start the servers 10A-10C in response to a start request from the server start function 22 of the client computer 20.

The server retrieval function 21 of the client computer 20 transmits an inquiry using the broadcast address (multicasting address) to the network in the same segment, and recognizes the server which can provide a target service in accordance with the replies from the servers.

The server start function 22 mounted on the client computer 20 cooperates with the remote power-up functions 14A-14C of the servers 10A-10C and start only server candidates which can provide services. If it is assumed that the service which is intended to be used by the client computer 20 is the first service 15A, the server start function 22 starts only the first server 10A capable of providing the first service 15A. In a case in which the service is composed of a plurality of server groups (master or slave server, cluster server, etc.), the server start function 22 starts all the server candidates capable of providing the service.

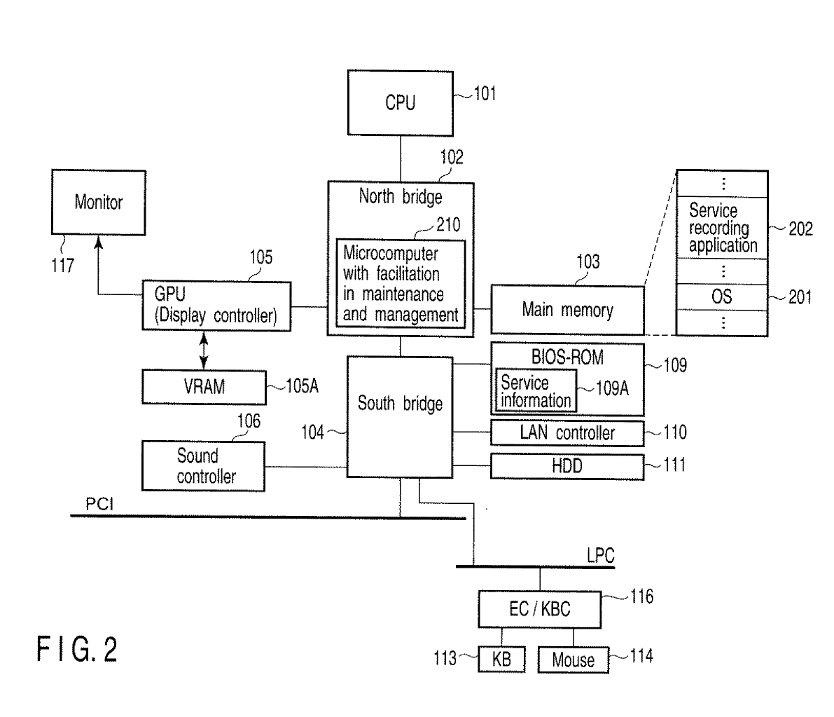

Referring now to FIG. 2, system x configurations of the first to third servers 10A-10C will be described.

Each server 10A-10C includes, as shown in FIG. 2, a CPU 101 a north bridge 102, a main memory 103, a south bridge 104, a graphics processing unit (CPU) 105, a video memory (VRAM) 105A, a sound controller 106, the BIOS-ROM 109, a LAN controller 110, a hard disk drive (HDD) 111, and an embedded controller/keyboard controller IC (EC/KBC) 116.

The CPU 101 is a processor to control operations of each server 10A-10C, and carries out an operating system (OS) 201 to be loaded from the HDD 111 into the main memory 103 and various application programs such as a service record application program 202. The application program 202 is software for actualizing a part of the service recording functions 11A-11C. The application program 202 collects services which can be provided to the client computer 20 from the servers 10A-10C, and instructs processing for writing the collected service in a BIOS-ROM 109 that is the nonvolatile memory as service information 109A to a microcomputer with facilitation in maintenance and management 210. The CPU 101 also carries out the BIOS stored in the BIOS-ROM 109 that is the nonvolatile memory. The BIOS is a program for controlling hardware.

The north bridge 102 is a bridge device for connecting between a local bus in the CPU 101 and the south bridge 104. The north bridge 102 has a memory controller for applying access control to the main memory 103 built-in. The north bridge 102 also has a function of communication with the GPU 105 via a serial bus of the PCI EXPRESS standard, etc.

The north bridge 102 has the microcomputer with facilitation in maintenance and management 210 for actualizing a part of the service record functions 11A-11C and the service notifying functions 13A-13C. The service notifying functions 13A-13C each have function of accessing the BIOS-ROM 109 composed of the nonvolatile memory through the south bridge 104. The microcomputer 210 reads data stored in an area of the service information 109A of the BIOS-ROM 109 that is the nonvolatile memory in response to a request for notify of the service from the client computer 20 and notifies the service to the client computer 20.

The CPU 105 is a display controller for controlling a monitor 117 to be used as a display monitor of each server 10A-10C. A display signal to be generated from the GPU 105 is transmitted to the monitor 117.

The south bridge 104 controls each device on a Low Pin Count (LPC) bus and each device on a Peripheral Component Interconnect (PCI) bus. The south bridge 104 has an Integrated Drive Electronics (IDE) controller for controlling the HDD 111 built-in.

The LAN controller 110 is a communication device which carries out, for example, wired communication based on a 1000 BASE-T/TX standard. The LAN controller 110 is, For example, an 82566 DM gigabit network connection made by Intel.

The EC/KBC IC 116 is one-chip microcomputer with an embedded controller for power management, and a keyboard controller for controlling a keyboard 113 and a mouse 114 integrated therein. The EC/KBC IC 116 has a function of turning on/off each server 10A-10C in response to operations of a power button by the user.

Even in a power ‘off’ state where the OS does not operate, the standby power supply is supplied to the north bridge 102, the south bridge 104, the LAN controller 110, and the FC/KBC 116.

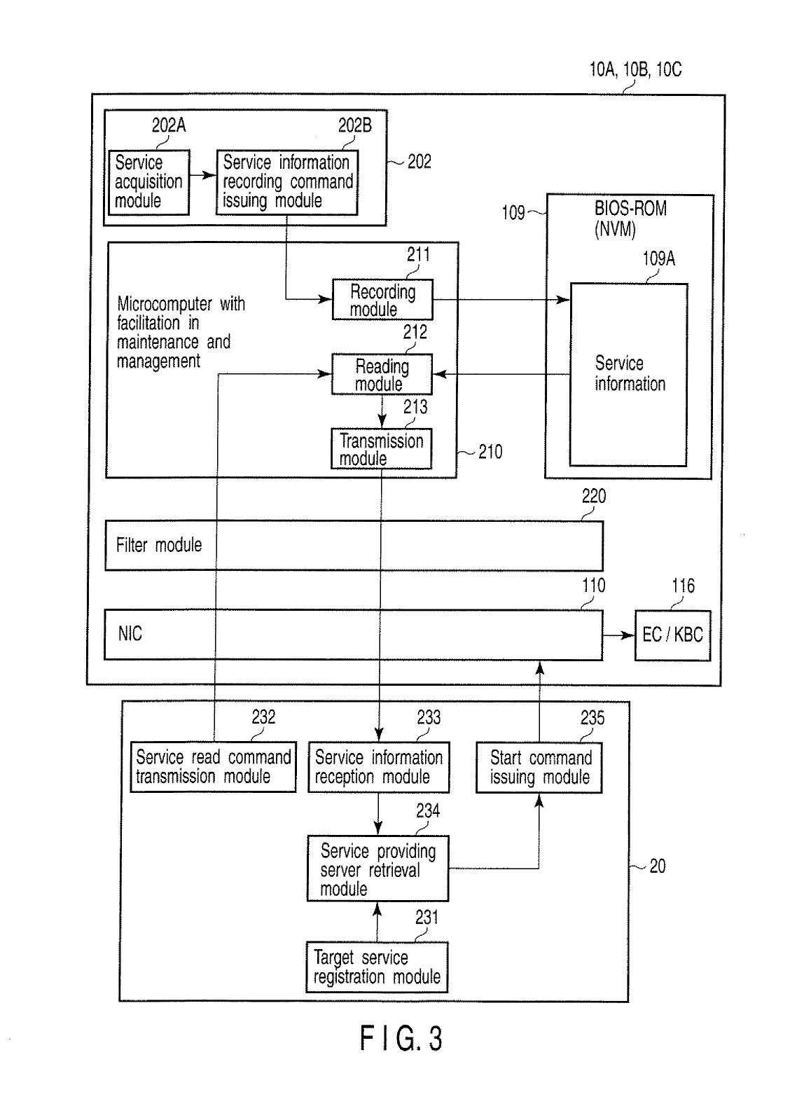

The following will describe a configuration which records services to be provided from the servers 10A-10C in the nonvolatile memory (NVM), replies the service information recorded in the NVM in response to the request from the client computer 20, and starts in response to the request from the client computer 20, by referring to FIG. 3. A configuration, in which the client computer 20 requires the service information to the servers 10A-10C and makes the servers 10A-10C which provide the target service start, will be described with reference to FIG. 3.

The servers 10A-10C includes the service record application program 202, the microcomputer with facilitation in maintenance and management 210, the BIOS-ROM (NVM) 109, the LAN controller (NIC) 110 and a filter module 220.

The application program 202 includes a service acquisition module 202A, and a service information record command issuing module 202B. The service acquisition module 202A acquires service information which can be provided and notifies the kind of the acquired service to the issuing module 202B in setting the service or in taking over the service. The service acquisition module 202A can execute by retrieving, for example, an execution file of an application program which provides a specific service. In a case where a single application program can provide a plurality of services, services to be provided are recorded in advance in a property of the execution file of application program, and the service acquisition module 202A detects the services to be provided by referring to the property of the execution file.

The issuing module 202B transmits a command for writing the notified kinds of services in the BIOS-ROM 109 to the microcomputer 210.

The microcomputer 210 includes a recording module 211, a reading module 212 and a transmission module 213. The recording module 211 records the kinds of the services capable of being provided by the servers 10A-10C in response to the command issued from the issuing module 202B in the service information 109A in the BIOS-ROM (NVM) 109.

The reading module 212 reads the service information 109A stored in the BIOS-ROM 109 to notify the read service information to the transmission module 213. The transmission module 213 transmits the notified service information to the client computer 20.

The filter module 220 transfers the data transmitted to a specific port number to the microcomputer 210. The client computer 20 transmits the data to be transmitted to the microcomputer 210 to the specific port number.

The LAN controller (NIC) 110 is disposed for communicating with client computer 20, etc., connected to the network. The LAN controller 110 has a function of issuing a command to the EC/KBC 116 so as to start the OS when the start command is issued from the client computer 20 in a case where the OS has not worked yet.

The client computer 20 includes a target service registration module 231, a service read command transmission module 232, a service information reception module 233, a service providing server retrieval module 234 and a start command issuing module 235.

The target service registration module 231 has a function of registering the target service which the user desires to receive and notifying the target service to a service providing server retrieval module 234 through client computer 20. The command transmission module 232 has a function of concurrently transmitting a read command (service information transmission request) for inquiring services which can be provided by the servers 10A-10C to the servers 10A-10C on the network in the same segment by using broadcast address (multicast address) in response to the starting time and the instruction from the user.

The information reception module 233 has a function of receiving the service information transmitted from the servers 10A-10C in response to the read command transmitted from the command transmission module 232 and notifying the received service information to the server retrieval module 234. The retrieval module 234 has a function of retrieving the server for providing the target service notified from the target service registration module 231 from the notified service information. The retrieval module 234 notifies the server providing the retrieved target service to the start command issuing module 235.

The start command issuing module 235 issues a start command for the notified server. The issuing module 235 transmits a special packet as a start command. For instance, the special packet is data in which 0xffffffffffff and a MAC address to be started are continued by 16 times continued from an IP header.

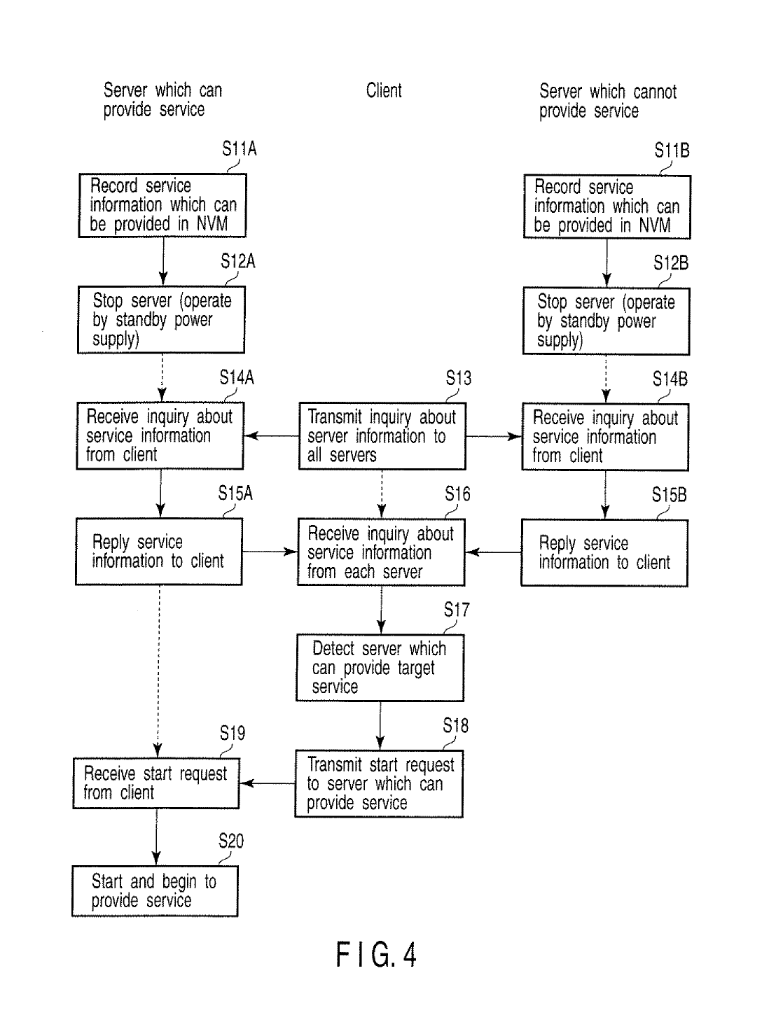

Next, a procedure of processing of each server 10A-10C and the client computer 20 will be described by referring to FIG. 4. The servers 10A-10C will be described by dividing into a group of servers which can provide services required by the client computer 20 and a group of servers which cannot provide those services.

The service acquisition module 202A of each server 10A-10C acquires information of services which can be provided in setting the services or in taking over the services. The acquisition module 202A notifies the acquired service information which can provide to the service information record command issuing module 202B. The issuing module 202B issues a command to the microcomputer 210 so as to record the service information in the BIOS-ROM 109. The recording module 211 of the microcomputer 210 records the service information in the BIOS-ROM 109 (Blocks S11A, S11B). Then, the servers stop and are in states in which the servers operate by the standby power supply and the servers which can provide the services required by the client computer 20 are made unclear (Blocks S12A, 12B).

The command transmission module 232 of the client computer 20 concurrently transmits the read command for inquiring the service information to all the servers connected to the network by using the broadcast address (multicast address) (Block S13). These inquiries are transmitted to preset specific port numbers.

When receiving the data transmitted to the specific port numbers, the filter module 220 transfers the received data to the microcomputer 210 (Blocks S14A, A14B). The reading module 212 of the microcomputer 210 reads the service information from the BIOS-ROM 109. The reading module 212 transfers the read service information to the transmission module 213. The transmission module 213 transmits the transferred service information to the client computer 20, and replies to the inquiry from the client computer 20 (Blocks S15A, S15B).

When the service information reception module 233 receives the service information from each server (Block S16), the reception module 233 transfers the service information to the service providing server retrieval module 234. The retrieval module 234 retrieves the servers which can provide the target services registered in the target service registration module 231 from the received service information (Block S17). The retrieval module 234 notifies the retrieved server to the start command issuing module 235. The issuing module 235 issues the start commands to the notified servers (Block S18).

When the LAN controller 110 of the server receives the start request from the client computer 20 (Block S19), the LAN controller 110 issues the command to the EC/KBC 116 so as to start the OS. After the EC/KBC 116 starts the processing system, the server operates to start providing the target service (Block S20).

According to the aforementioned processing, in an environment that which of the servers can provide the target service is unclear, and also in a state in which the servers operate by the standby power supply, the client computer 20 may start only the servers which can provide the target services.

The service notifying functions 13A-13C of the servers 10A-10C may transmit the service information stored in the BIOS-ROM 109 to all the equipment on the network in the same segment by using the broadcast address. By periodically transmitting the service information, since the service information is automatically provided from the servers in a state where the client computer 20 is disconnected from the network once and after the client computer 20 is connected to the network again, the services provided from the servers 10A-10C may be recognized.

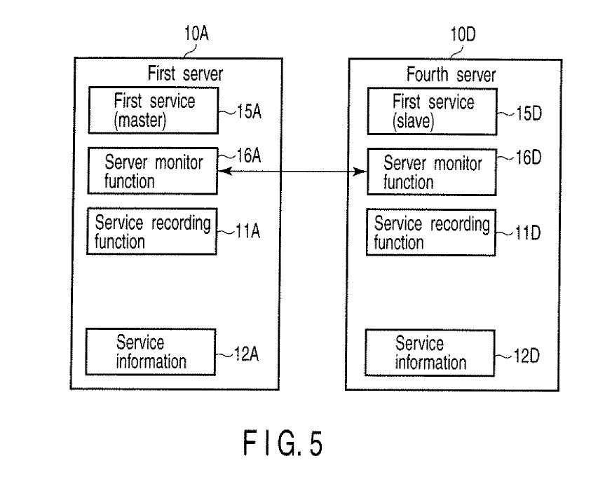

The service recording function of the server will be described with reference to FIGS. 5A and 5B. FIGS. 5A and 5B shows an example in which the record of the service information is updated when the master and slave relationships of the service is switched.

In the first server 10A and the fourth server 10D, the first service 15A, 15D operate, respectively, the first service 15A of the first server 10A operates as a master, and the first service 15D of the fourth server 10D operates as a slave. Server monitor functions 16A, 16D monitor the servers 10A and 10B mutually.

When the server monitor function 16D on the fourth server 10D detects a failure, the service recording function 11D changes the first service 15D on the fourth server 10D so as to operate as the master as shown at of FIG. 5B and the fourth server 10D instructs the recording function 11D so as to rewrite the service function 12D. Before the failure occurs at the first server 10A as shown at FIG. 5A, the fact the first service 15D operates as the slave on the fourth server 10D has been recorded in the service information 12D. However, after the failure occurs on the first server 10A as shown at FIG. 5B, the service recording function 11D recognized and rewrites as if the first service 15D operates as the master on the fourth server 10D.

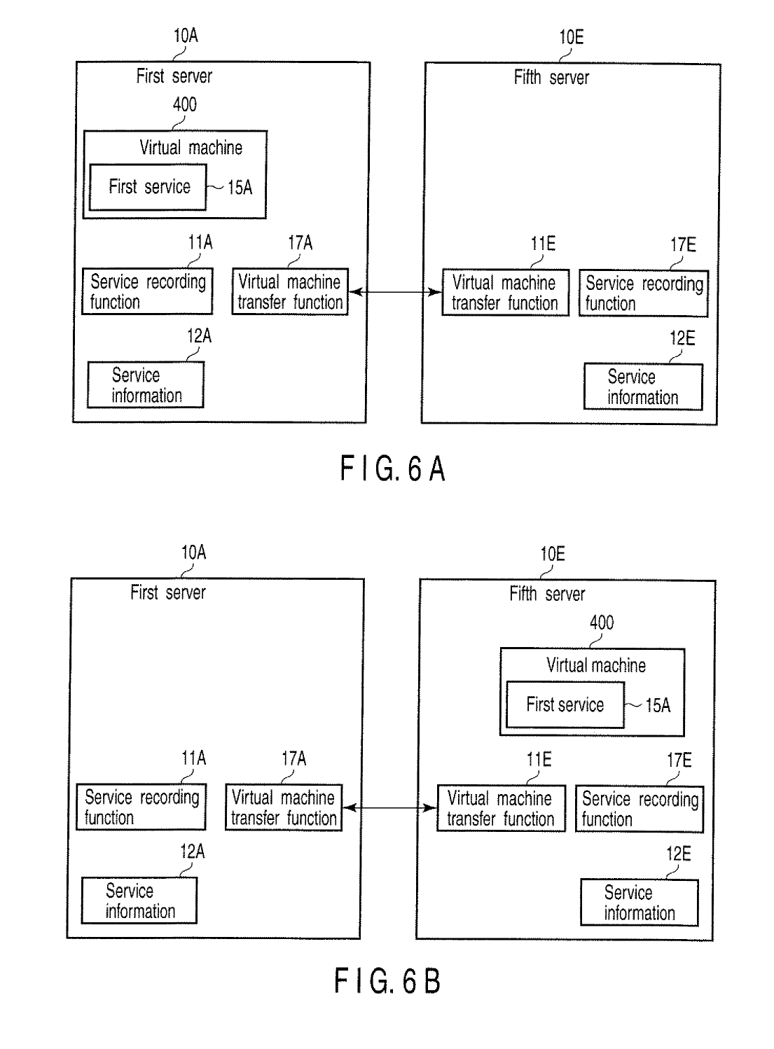

Another example will be described by referring to FIGS. 6A and 6B. FIGS. 6A and 6B shows a case in which a plurality of virtual machines provide services by using operable virtual techniques on single hardware. FIGS. 6A and 6B shows an example in which the record of the service information is updated in a case where a virtual machine 400 having an environment providing a first service 15A is transferred from the first server 10A to a fifth server 10E.

With a virtual machine transfer function 17A of the first server 10A and a virtual machine transfer function 17E of the fifth server 10E cooperated, the transfer of the virtual machine 400 from the first server 10A to the fifth server 10E results in transfer of the environment providing the first service 15A. At the moment, the virtual machine transfer function 17A of the first server 10A notifies that the first service 15A has been transferred to the service recording function 11A. The service recording function 11A of the first server 10A updates and records service information 12A so that the first service 15A does not exist. The virtual machine transfer function 17E of the second server 10E notifies that a virtual machine providing the first service 15A has been transferred to a service recording function 11E. The service recording function 11E updates and records service information 12E so that the first service 15A exists.

The service recording function 11A is an application program which operates on a virtual machine other than the virtual machine 400. The service recording function 11E is an application program which operates on a host OS managing the virtual machine 400. The virtual machine transfer functions 17A, 17E are application programs which operate on the host OS managing the virtual machine 400.

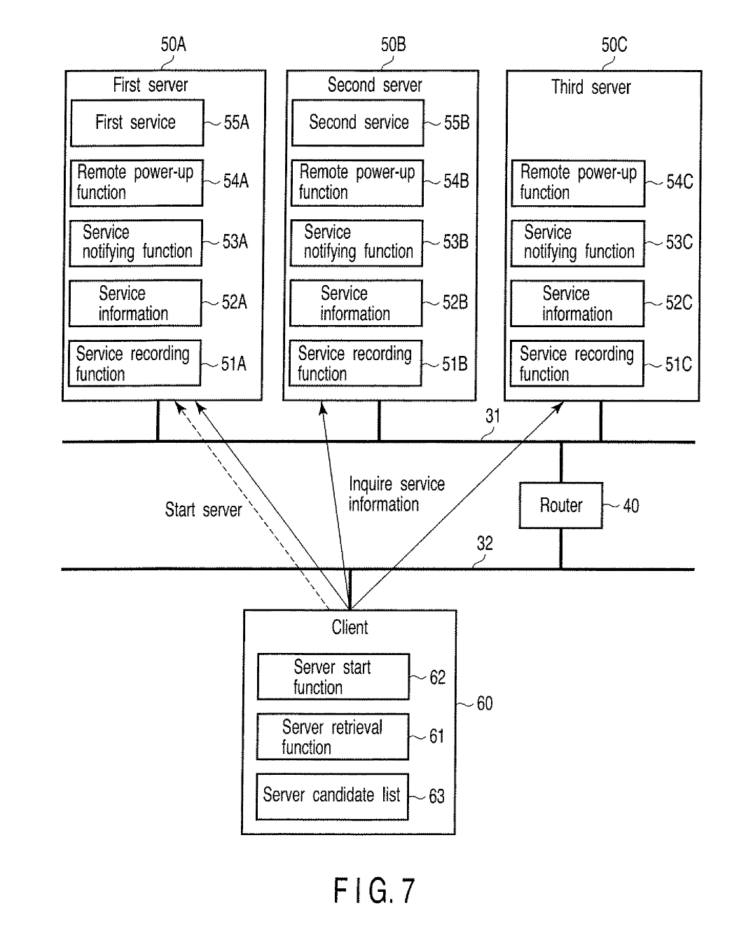

Referring now to FIG. 7, a case in which servers 50A-50C and a client computer 60 are connected to a network in different segments via a router 40 will be described. The client computer 60 includes a server retrieval function 61, a server start function 62 and a server candidate list 63. The client computer 60 is connected to a network 32. The server candidate list 63 is a list of addresses of the servers 50A-50C on a network 31 in a segment which is different from the network 32 with the client computer 60 connected thereto.

The server retrieval function 61 individually inquires to addresses (servers) registered on the candidate list 63 about services which they can provide. Depending on the reply from each server, the retrieval function 61 detects the servers capable of providing the target services. The server start function 62 starts servers in cooperation with remote power-up functions of the servers in order to receive the target services.

Since the configurations of the servers 50A-50C are the same of those of the servers 10A-10C which have been described by the use of FIG. 3, descriptions of the servers 50A-50C will be omitted.

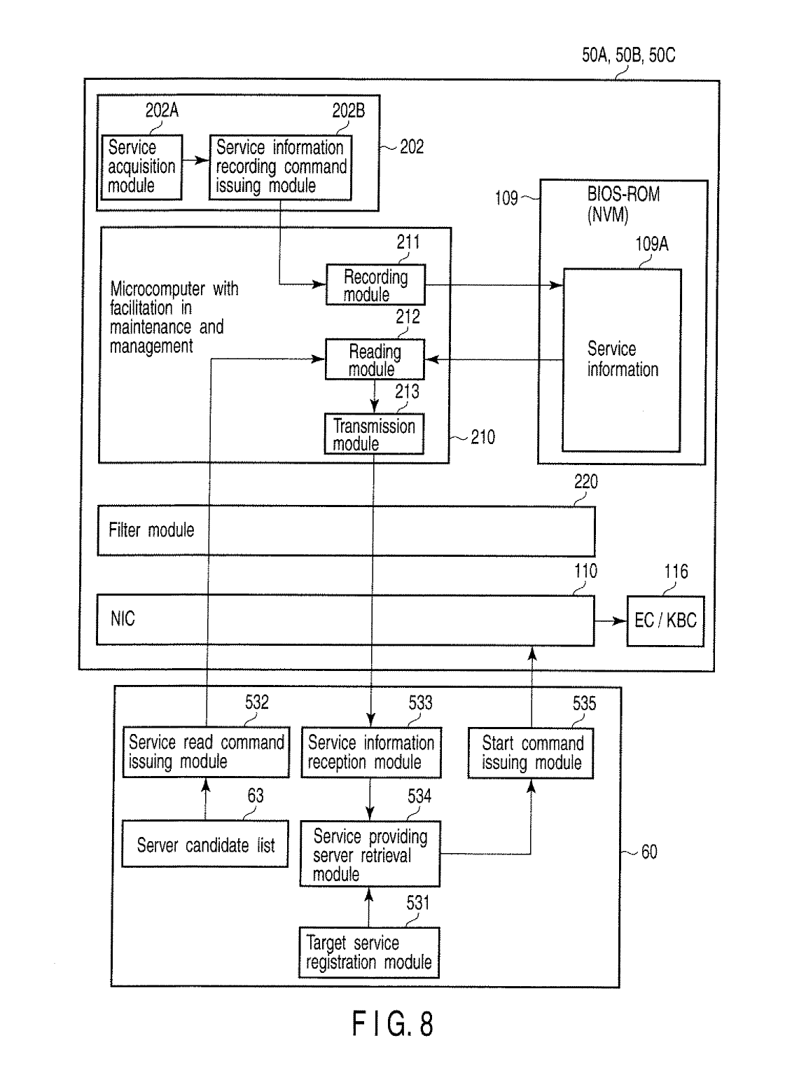

The following will describe a configuration in which the information processing system records services to be provided from the servers in a NVM, replies the service information recorded in the NVM in response to a request from the client computer 60, and the servers start in response to a request from the client computer 60. Referring to FIG. 8, a configuration by which the client computer 60 inquires the service information to the servers 50A-50C and starting the servers which provide the target services.

Since the configurations of the servers 50A-50C are the same of those of the servers 10A-10C which have been described by the use of FIG. 3, descriptions of the servers 50A-50C will be omitted.

The client computer 60 includes a server candidate list 63, a target service registration module 531, a service read command issuing module 532, a service information reception module 533, a service providing server retrieval module 534 and a start command issuing module 535.

The server candidate list 63 is a list of the addresses of the servers 50A-50C on the network in the different segments.

The target service registration module 531 has a function of registering the target service which is desired by the user through the client computer 60, and notifying the target service to the service providing server retrieve module 534. The service read command transmission module 532 has a function of individually transmitting read commands (service information transmission requests) for inquiring services which can be provided from the servers 50A-50C to the servers 50A-50C in starting or in response to an instruction from the user.

The service information reception module 533 receives the service information transmitted from the servers 5A-50C in response to the read command transmitted from the command issuing module 532, and notifying the received service information to the server retrieval module 534. The server retrieval module 534 has a function to retrieve the target service notified from the service registration module 531. The server retrieval module 534 notifies the server which provides the retrieved target to the command issuing module 535.

The command issuing module 535 issues a start command to the notified server. The command issuing module 535 is a special packet as a start command. For instance, the special packet is data in which the 0xffffffffffff and a MAC address of a start object followed an IP header.

If it is assumed that the service which is intended to use by the client computer 60 is the first service 15A, the command issuing module 535 starts only the first server 50A capable of providing the first service 15A. If the service is composed of a plurality of server groups (master/slave, cluster, etc.), the command issuing module 535 starts all the server candidates capable of providing the service.

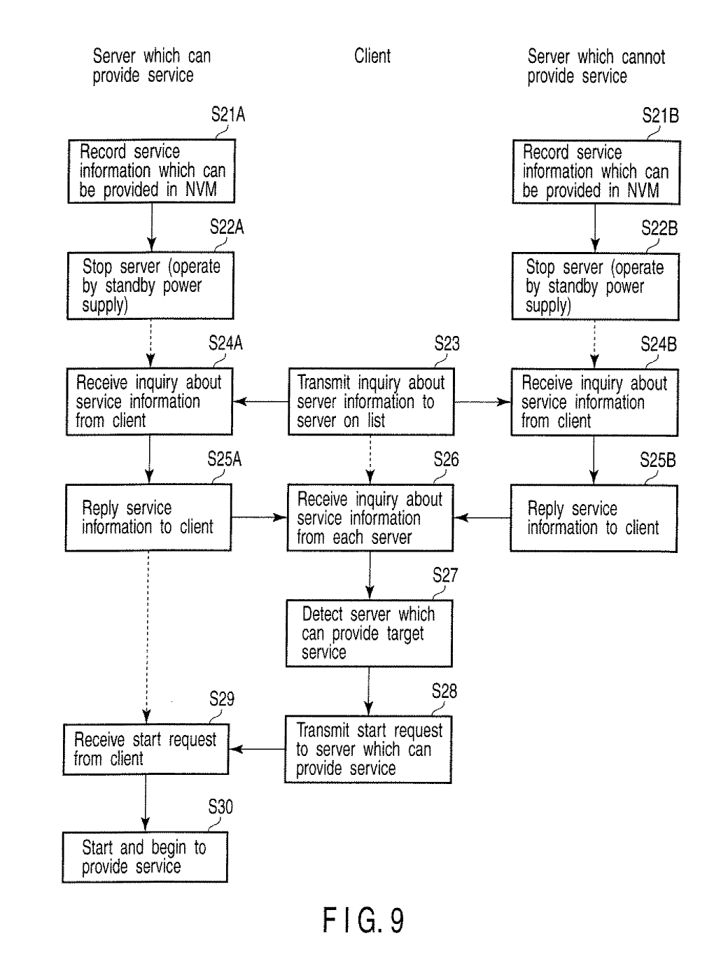

Procedures of each server 50A-50C and the client computer 60 will be described with reference to FIG. 9. The servers 50A-50C will be described by dividing into a group of servers which can provide services required from the client computer 60 and a group of servers which cannot provide those services.

The service acquisition module 202A of each server acquires the service information capable of being provided in setting the services, or in taking over the services. The acquisition module 202A notifies the acquired service information which can be provided to the command issuing module 202B. The command issuing module 202B commands the microcomputer with facilitation in maintenance and management 210 so as to record the service information in the BIOS-ROM 109 (Blocks S21A, S21B). Then, the server stops, the server is brought into a state where the server operates by the standby power supply, and the processing system is brought into a state where the server for providing the service required from the client computer 60 is unclear (Blocks S22A, 22B).

The command issuing module 532 of the client computer 60 refers to the server candidate list 63 and sequentially transmits read commands for inquiring the service information to each server on the list 63 (Block S53). These inquiries are transmitted to the specific port numbers to be set in advance.

When receiving the data transmitted to the specific port number, the filter module 220 transfers the received data to the microcomputer 210 (Blocks S24A, S24B). The reading module 212 of the microcomputer 210 reads the service information from the BIOS-ROM 109 in response to the read command. The reading module 212 transfers the read service information to the transmission module 213. The transmission module 213 transmits the transferred service information to the client computer 60 to reply for the inquiries from the client computer 60 (Blocks S25A, S25B).

When receiving the service information from each server (Block S26), the service information reception module 533 transfers the service information to the service providing server retrieval module 534. The server retrieval module 534 retrieves the servers which can provide the target service registered in the target service registration module 531 from the received service information (Block S27). The server retrieval module 534 notifies the retrieved servers to the command issuing module 535. The command issuing module 535 issues the start request to the notified server (Block 328).

When the LAN controller 110 receives the start request from the client computer 60 (Block S29), the LAN controller 110 commands the EC/KBC 116 so as to start the operating system (OS). After the EC/KBC 116 starts the operating system, the server operates and starts to provide the target service (Block S30).

According to the aforementioned processing, the processing system can start only the servers which can provide the target service without starting all the servers in a state where the servers operate by the standby power supply in the environment that it is not clear for the user to recognize the servers which can provide the target service.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing system including a service receiving apparatus connected to a network and a plurality of service providing apparatuses which provide services to the service receiving apparatus via the network, wherein
each of the plurality of service providing apparatuses includes:
a nonvolatile memory configure to store service information that is information of all services which can be provided to the service receiving apparatus;
a service information transmission module configured to transmit information stored in the nonvolatile memory to the service receiving apparatus in response to a service information transmission request transmitted from the service receiving apparatus in a power ‘off’ state where a system does not operate; and
a system start module configured to start the system in response to a start command transmitted from the service receiving apparatus in the power ‘off’ state, and
the service receiving apparatus includes:
a transmission request transmission module configured to transmit the service information transmission request to the service providing apparatuses in the power ‘off’ states;
a selecting module configured to select service providing apparatuses which provide predetermined services from the plurality of service providing apparatuses in response to the service information transmitted from the service providing apparatuses in response to the service information transmission request; and
a start command transmission module configured to transmit the start commands to the selected service providing apparatuses.

2. The information processing system according to claim 1, wherein the selecting module selects all the service providing apparatus which can provide the predetermined services.

3. The information processing system according to claim 1, wherein the transmission request transmission module transmits the service information transmission request to all the service providing apparatuses connected to the network in the same segment as that of the service receiving apparatus by using a broadcast address.

4. The information processing system according to claim 1, wherein the service receiving apparatus includes a list of addresses of servers connected to a network in a different segment from that of the service receiving apparatus.

5. The information processing system according to claim 1, wherein the service providing apparatuses transmit the service information stored in the nonvolatile memory to all the service receiving apparatuses connected to the network in the same segment as that of the service providing apparatuses by using a broadcast address.

6. A control method of an information processing system including a service receiving apparatus connected to a network and a plurality of service providing apparatuses which provide services to the service receiving apparatus via the network, comprising:
causing the service receiving apparatus to inquire services, which can be provided to the service receiving apparatus by the service providing apparatuses, to each of the service providing apparatus in a power ‘off’ state where a system does not operate,
causing each of the plurality of service providing apparatuses to transmit service information stored in a nonvolatile memory disposed at each service providing apparatus to the service receiving apparatus,
causing the service receiving apparatus to detect service providing apparatuses which can provide predetermined services on the basis of the service information transmitted from the service providing apparatuses;
causing the service receiving apparatus to transmit the start commands for starting the service providing apparatuses to the detected service providing apparatuses; and
causing the service providing apparatuses having received the start commands to start.

7. The control method according to claim 6, wherein the service receiving apparatus transmits the start commands to all the service apparatuses which is configured to provide the predetermined services.

8. The control method according to claim 6, wherein transmitting the service information transmission request is performed to all the service providing apparatuses connected to the network in the same segment as that of the service receiving apparatus by using a broadcast address.

9. The control method according to claim 6, wherein the service receiving apparatus includes a list of addresses of the servers connected to the network in a different segment from that of the service receiving apparatus, and
transmitting the service information transmission request is individually performed to the servers on the list.

10. A control method of an information processing system including a service receiving apparatus connected to a network and a plurality of service providing apparatuses which provide services to the service receiving apparatus via the network, comprising:
causing each of the plurality of service providing apparatuses to transmit service information stored in a nonvolatile memory disposed at each service providing apparatus to the service receiving apparatus;
causing the service receiving apparatus to detect service providing apparatuses which can provide predetermined services on the basis of the service information transmitted from the service providing apparatus
transmitting the start commands for starting the service providing apparatuses to the detected service providing apparatuses; and
causing the service providing apparatuses having received the start commands to start.

11. The control method according to claim 10, wherein the service providing apparatus transmits the service information stored in the nonvolatile memory to all the service receiving apparatuses connected to the network in the same segment as that of the service providing apparatuses by using a broadcast address.
